(19) United States
(12) Patent Application Publication
(10) Pub. No.: US 2011/0104568 A1
(43) Pub. Date: May 5, 2011

(54) Negative Electrode For Rechargeable Lithium Battery and Rechargeable Lithium Battery Including Same

(76) Inventors: Min-Seok Sung, Yongin-si (KR); Goo-Jin Jeong, Yongin-si (KR); Sang-Min Lee, Yongin-si (KR); Kyeu-Yoon Sheem, Yongin-si (KR); Yong-Mook Kang, Yongin-si (KR); Sung-Soo Kim, Yongin-si (KR)

(21) Appl. No.: 12/901,415

(22) Filed: Oct. 8, 2010

(30) Foreign Application Priority Data
Nov. 4, 2009 (KR) 10-2009-0106196

(51) Int. Cl. H01M 4/54; H01M 4/52; H01M 4/58

(52) U.S. Cl. 429/219; 429/220; 429/221; 429/222; 429/229; 429/231.5; 429/231.6

(57) ABSTRACT

A negative electrode for a rechargeable lithium battery and a rechargeable lithium battery including the same, the negative electrode including a current collector; and an active material layer formed on the current collector. The active material layer includes a solid solution of a metallic component, and an active material that is capable of forming a lithium-included compound, the metallic component selected from Cu, Ti, a Cu—X alloy, a Ti—X alloy, and a combination thereof. In the alloys, X is selected from an alkaline metal, an alkaline-earth metal, a Group 13 element excluding Ti, a Group 14 element, a transition element excluding Cu, a rare earth element, and a combination thereof.

### CROSS-REFERENCE TO RELATED APPLICATION

This application claims the benefit of Korean Patent Application No. 10-2009-0106196 filed in the Korean Intellectual Property Office on Nov. 4, 2009, the disclosure of which is incorporated herein, by reference.

### BACKGROUND

1. Field

This disclosure relates to a negative electrode for a rechargeable lithium battery and a rechargeable lithium battery including the same.

2. Description of the Related Art

Lithium rechargeable batteries have recently drawn attention as a power source of small portable electronic devices. They use an organic electrolyte solution and thereby, have twice the discharge voltage of a conventional battery using an alkaline aqueous solution. Accordingly, lithium rechargeable batteries have a high energy density. For positive active materials of a rechargeable lithium battery, lithium-transition element composite oxides capable of intercalating lithium, such as LiCoO₂, LiMn₂O₄, LiNi₁₋ₓCoₓO₂ (0<×<1), and so on, have been researched.

Conventionally, lithium metals have been used as a negative active material for rechargeable lithium batteries. However, the cycle-life of the battery may be shortened, due to the formation of dendrites, when the lithium metal is used. Therefore, carbonaceous materials, such as amorphous carbon, crystalline carbon, etc., have recently been used in place of lithium metals. The carbonaceous negative active material is resistant to the formation of dendrites, has a consistent voltage at a low potential, and exhibits good cycle-life characteristics. However, it has a high reactivity with an organic electrolyte solution, and a high diffusion rate for lithium. Therefore, the electric power characteristics, initial irreversible capacity, and electrode swelling when charged and discharged should be controlled.

In order to improve cycle-life, research has been conducted into using lithium alloys as a negative active material. U.S. Pat. No. 6,051,340 discloses a negative electrode including a metal not alloyed with lithium and a metal alloyed with lithium. In this patent, the metal not alloyed with lithium acts as a current collector, and the metal alloyed with lithium forms an alloy with lithium ions that are released from a positive electrode, during charging. Therefore, the negative electrode includes lithium during charging. The alloy functions as a negative active material. However, the lithium alloy does not exhibit satisfactory battery characteristics.

In addition, metallic negative active materials, such as silicon (Si), tin (Sn), a compound including Si or Sn, and so on, have recently been studied as a substituent of the carbonaceous material. However, Si and Sn exhibit large irreversible capacities. Particularly, Si undergoes substantial volume changes during charging and discharging and thereby, may result in a negative active material being detached, resulting in the deterioration of the cycle-life of a rechargeable lithium battery. Tin oxide, as disclosed by Japan Fuji Film. Co., Ltd., has come into the spotlight as an alternative to the carbonaceous negative active materials. However, the metal negative active material has 30% or less initial Coulomb efficiency. Further, as lithium is continuously intercalated and deintercalated to generate a lithium-metal alloy, the capacity and cycle-life thereof are decreased, resulting in a lack of commercialization.

Positive and negative electrodes of rechargeable lithium batteries are fabricated by applying a slurry composition including such active materials, binders, and optionally conductive materials, on current collectors. Aluminum for a positive current collector and copper for a negative electrode have been used. Accordingly, much research has recently been undertaken to improve the energy density of a rechargeable lithium battery.

### SUMMARY

One aspect of this disclosure provides a negative electrode for a rechargeable lithium battery, which can effectively absorb stresses produced during volume changes.

Another aspect of this disclosure provides a method of preparing a negative electrode for a rechargeable lithium battery.

Further, another aspect of this disclosure provides a rechargeable lithium battery including the negative electrode, having an excellent energy density and cycle-life characteristics.

According to one aspect, a negative electrode for a rechargeable lithium battery is provided that includes a current collector and an active material layer formed on the current collector. The active material layer includes a solid solution of a metallic component M and an active material being capable of forming a lithium-included compound. Metallic component M is selected from the group consisting of Cu, Ti, a Cu—X alloy, a Ti—X alloy, and a combination thereof. In these alloys, X is selected from the group consisting of an alkaline metal, an alkaline-earth metal, a Group 13 element excluding Ti, a Group 14 element, a transition element excluding Cu, a rare earth element, and a combination thereof.

According to some embodiments, the active material layer may have a porosity of about 10 to about 70 volume %.

According to some embodiments, the metallic component M may be a metal solid solution represented by Chemical Formula LₓN_{y}, wherein L is Cu, Ti, or a combination thereof, N is an alkaline metal, an alkaline-earth metal, a Group 13 element excluding Ti, a Group 14 element, a transition element excluding Cu, a rare earth element, or a combination thereof. In the Chemical Formula LₓN_{y}, x ranges from 70 to 100 wt %, and y ranges from 0 to 30 wt %).

According to some embodiments, the active material may be selected from the group consisting of Si, Sn, an Si-Q1 alloy, an Sn-Q2 alloy, and a combination thereof. Q1 and Q2 are independently an alkaline metal, an alkaline-earth metal, a Group 13 element, a Group 14 element excluding Si and Sn, a transition element, a rare earth element, and a combination thereof.

According to another aspect of this disclosure, a method of fabricating a negative electrode for a rechargeable lithium battery is provided that includes: mixing an active material powder and a metallic component M powder, to form a mixture. The metallic component M is selected from Cu, Ti, a Cu—X alloy, a Ti—X alloy, and a combination thereof. In the alloys, X is selected from an alkaline metal, an alkaline-earth metal, a Group 13 element excluding Ti, a Group 14 element, a transition element excluding Cu, a rare earth element, or a combination thereof. The method further includes thermal-spraying the mixture onto a current collector, to form an active material layer.

According to some embodiments, the active material powder may have an average particle size of 100 nm to 1 μm, and the metallic component M powder may have an average particle size of about 100 nm to about 1 μm.

According to some embodiments, the active material powder and the metallic component M powder may be mixed at a weight ratio of about 30:70 to about 70:30.

According to some embodiments, the thermal-spraying process may be performed by plasma spraying, arc spraying, high velocity oxygen fuel spraying, gas spraying, or a combination thereof. In addition, the thermal-spraying may be performed at a temperature of about 10000 to about 18000° C., at a spraying speed of about 100 to about 400 m/sec.

According to further another aspect, provided is a rechargeable lithium battery including the negative electrode, a positive electrode, and an electrolyte.

The negative electrode for a rechargeable lithium battery, according to one aspect, suppresses the expansion of the active material during charging and discharging and has an excellent adherence to the current collector, so it is possible to improve battery characteristics and cycle-life characteristics of the rechargeable lithium battery.

Additional aspects and/or advantages of the present teachings will be set forth in part in the description which follows and, in part, will be obvious from the description, or may be learned by practice of the present teachings.

### BRIEF DESCRIPTION OF THE DRAWINGS

These and/or other aspects and advantages of the present teachings will become apparent and more readily appreciated from the following description of the exemplary embodiments, taken in conjunction with the accompanying drawings, of which:

FIG. 1 shows a schematic view of a negative electrode according to an exemplary embodiment;

FIG. 2 is a flow chart showing a method of fabricating a negative electrode, according to an exemplary embodiment; and

FIG. 3 is a cross-sectional view of a rechargeable lithium battery, according to an exemplary embodiment.

### DETAILED DESCRIPTION OF THE EXEMPLARY EMBODIMENTS

Reference will now be made in detail to the exemplary embodiments of the present teachings, examples of which are illustrated in the accompanying drawings, wherein like reference numerals refer to the like elements throughout. The exemplary embodiments are described below, in order to explain the present disclosure, by referring to the figures.

In a rechargeable lithium battery, active materials included in an electrode may expand and contract when the rechargeable lithium battery is charged and discharged. In particular, a silicon-based negative active material undergoes severe volume changes. The volume changes of the active materials may deteriorate cycle-life characteristic of the rechargeable lithium battery.

According to one exemplary embodiment, a mixture of an active material and a metallic powder is thermally sprayed, to form an active material layer. Therefore, the active material layer can withstand stresses resulting from changes in the volume of the active material, during charging and discharging. Therefore, the battery characteristics and cycle-life of the rechargeable lithium battery are improved.

That is, a negative electrode, according to one embodiment, includes a current collector and an active material layer formed on the current collector. The active material layer includes a solid solution of a metallic component M and an active material that is capable of forming a lithium-included compound. Metallic component M is selected from Cu, Ti, a Cu—X alloy, a Ti—X alloy, and a combination thereof. In these alloys, X is selected from an alkaline metal, an alkaline-earth metal, a Group 13 element excluding Ti, a Group 14 element, a transition element excluding Cu, a rare earth element, and a combination thereof.

The active material layer does not include an additional conductive agent or binder, according to some embodiments. The metallic component M may be represented by LₓN_{y}, wherein, L is Cu, Ti, or a combination thereof; N is selected from an alkaline metal, an alkaline-earth metal, a Group 13 element excluding Ti, a Group 14 element, a transition element excluding Cu, a rare earth element, or a combination thereof, x ranges from about 70 to 100 wt %, and y ranges from about 0 to 30 wt %. The metallic component M may be in the form of a solid solution.

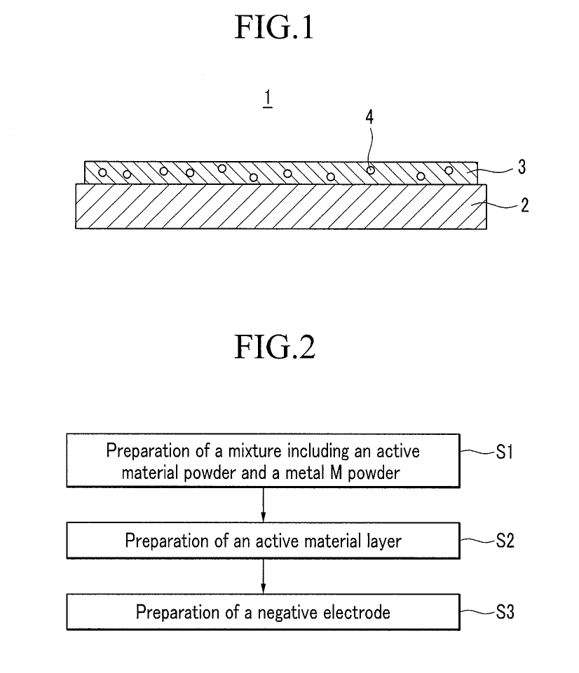

FIG. 1 is a cross-sectional view of a negative electrode 1 for a rechargeable lithium battery, according to an exemplary embodiment, but the present invention is not limited thereto. Referring to FIG. 1, the electrode 1 includes a current collector 2 and an active material layer 3 disposed on the current collector 2. The active material layer 3 may be porous.

The current collector 2 may include a copper foil, a nickel foil, a stainless steel foil, a titanium foil, a nickel foam, a copper foam, and a polymer material coated with a conductive metal. In particular, the current collector 2 may be formed of a copper foil or a nickel foil. The polymer may be selected from polyethylene terephthalate, polyimide, polytetrafluoroethylene, polyethylene naphthalate, polypropylene, polyethylene, polyester, polyvinylidene fluoride, polysulfone, copolymers thereof, or a combination thereof.

Then, the active material layer 3 is disposed on the current collector 2. The active material layer 3 may include a solid solution of the metallic component M and the active material.

The negative electrode for a rechargeable lithium battery, according to one exemplary embodiment, is formed by thermal-spraying a mixture of the active material and the metallic component M, which are in powder form, onto a current collector. While the mixture passes through the inside of a high-temperature heating source, the metallic component M is completely fused, and the surface of active material powder is fused, prior to impacting the current collector. In particular, only the surface of the active material powder is fused. However, the metallic component M is completely fused. The active material particles having fused surfaces contact the completely-fused metallic component M. This results in the active material particles being driven inside the fused metallic component M and disposed on the current collector. It is then possible to suppress the expansion of the active material, since the active material particles are strongly connected by the fused metallic component M. The metallic component M may operate as a binder and a conductive material, so it is possible to conveniently provide a negative electrode, without adding an additional conductive agent and/or binder, as in a conventional an active material layer.

Generally, an active material particle, such as Si, and a metal form a brittle inter-metallic compound having a low mechanical strength. However, according to one exemplary embodiment, the thermal spraying process results in high speed fusing and cooling, so it is possible to suppress the formation of such an inter-metallic compound.

In addition, the obtained active material layer may be porous, due to the fusion of the active material powder and the metallic component M powder. The obtained active material layer may have a porosity of about 10 to 70 volume %, or for example, a porosity of about 20 to 50 volume %. Such a porosity allows the active material layer to absorb the stresses resulting from volume changes, while maintaining a suitable mechanical strength, and also facilitates the permeation of an electrolyte solution.

In addition, since the active material layer is in the form of an alloy, the mechanical strength thereof is significantly better than that of a conventional active material including organic materials, such as a conductive agent and a binder. Since the active material layer is adhered to the current collector by the fusion of the powders, the active material layer is highly resistant to delamination from the current collector.

Furthermore, the active material is capable of forming a lithium-included compound. The active material may be selected from Si, Sn, an Si-Q1 alloy, Sn-Q2 alloy, and a combination thereof. In these alloys, Q1 and Q2 are independently an alkaline metal, an alkaline-earth metal, a Group 13 element, a Group 14 element excluding Si and Sn, a transition element, a rare earth element, or a combination thereof.

In particular, Q1 and Q2 may be independently selected from Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, Ti, Ge, P, As, Sb, Bi, S, Se, Te, Po, and a combination thereof. In one exemplary embodiment, the active material includes Si and/or Sn.

The active material may be included at 50 wt % or more, or 60 to 70 wt %, based on the total weight of active material layer. When the active material layer is included at 50 wt % or more, it is possible to show a suitable battery capacity.

The metallic component M may be selected from Cu, Ti, Cu—X alloy, a Ti—X alloy, and a combination thereof. In these alloys, X may be an alkaline metal, an alkaline-earth metal, a Group 13 element excluding Ti, a Group 14 element, a transition element excluding Cu, a rare earth element, or a combination thereof. In particular, X may be Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Ag, Au, Zn, Cd, B, Al, Ga, In, Si, Ge, Sn, P, As, Sb, Bi, S, Se, Te, Po, or a combination thereof. In one embodiment, X is Mg, Al, or a combination thereof. The metallic component M may be represented by Chemical Formula LₓN_{y}, wherein L is Cu, Ti, or a combination thereof; N is an alkaline metal, an alkaline-earth metal, a Group 13 element excluding Ti, a Group 14 element, a transition element excluding Cu, a rare earth element, or a combination thereof. In addition, x ranges from about 70 to 100 wt %; and y ranges from about 0 to 30 wt %.

The negative electrode for a rechargeable lithium battery, according to one embodiment, may be fabricated by mixing the active material powder and the metallic component M powder, to produce a mixture. The mixture is then thermal-sprayed onto a current collector, to produce an active material layer.

FIG. 2 is a flow chart showing a method of fabricating a negative electrode, according to one exemplary embodiment. Referring to FIGS. 1 and 2, the active material powder and the metallic component M powder are mixed, to produce a mixture (S1).

The active material powder may have an average particle size of about 100 nm to 1 μm or, for example, an average particle size of about 200 nm to 500 nm. When the active material powder has such an average particle size, the structure and initial efficiency of active material is maintained, resulting in good the cycle-life characteristics.

The metallic component M powder may have an average particle size of about 100 nm to 1 μm or, for example, an average particle size of 200 nm to 500 nm. When the metallic component M powder has such an average particle size, it is easier to conjugate the mixture, so a reduction of reversible efficiency, caused by covering the surface of active material, does not substantially occur.

The active material powder and metallic component M powder may be mixed at a weight ratio of about 30:70 to about 70:30 or, for example, a weight ratio of about 40:60 to about 60:40. When the active material powder and the metallic component M powder are mixed within such a range, suitable conductivity, capacity retention, and heating efficiency are produced.

Then the obtained mixture is thermally sprayed onto a current collector, to form an active material layer (S2). The current collector is as recited above.

The thermal spraying process does not significantly affect the characteristics of the mixture materials or of the current collector 2. The thermal spraying process may be, for example, plasma spraying, Arc spraying, high velocity oxygen fuel spraying (HVOF), gas spraying, and the like. The thermal spraying process may be easily performed under an air atmosphere, and it is possible to easily control the characteristics of active material layer, by adjusting the spraying speed, temperature, or the like.

According to one exemplary embodiment, the negative electrode is thermal sprayed at a temperature ranging from about 10000 to 18000° C. or, for example, a temperature ranging from about 12000 to about 15000° C. When the thermal spraying process is performed within such a temperature range, the surface of active material is fused, and metal M powder is completely fused so that a solid solution of metallic component M is easily produced and the resulting active material is inserted into the solid solution of metallic component M. Furthermore, it is possible to provide an active material layer having a suitable porosity.

During the thermal spraying process, the powder mixture may be sprayed at about 100 to 400 m/sec or, for example, about 200 to 300 m/sec. When the powder mixture is sprayed within such a range, it is possible to suitably form a solid solution of the metallic component M so that a solid solution of metallic component M is easily produced. The resulting active material 3 layer also has a suitable porosity. In addition, the surface of active material is sufficiently fused to the metallic component M.

As a result, the negative electrode 1 is produced (S3). The active material layer 3 of the negative electrode 1 is porous and the active material particles being driven inside the solid solution of metallic component M on the current collector 2.

Since the metallic component M has excellent electric conductivity and uniformly surrounds the active material, the active material layer 3 has excellent conductivity and adherence to the current collector 2. In addition, an additional conductive material and binder are not required. Since the active material is strongly connected to the metallic component M, it is possible to suppress the expansion of the active material layer 3, during charging and discharging. As a result, the negative electrode 1 exhibits a high-capacity and excellent cycle-life characteristics.

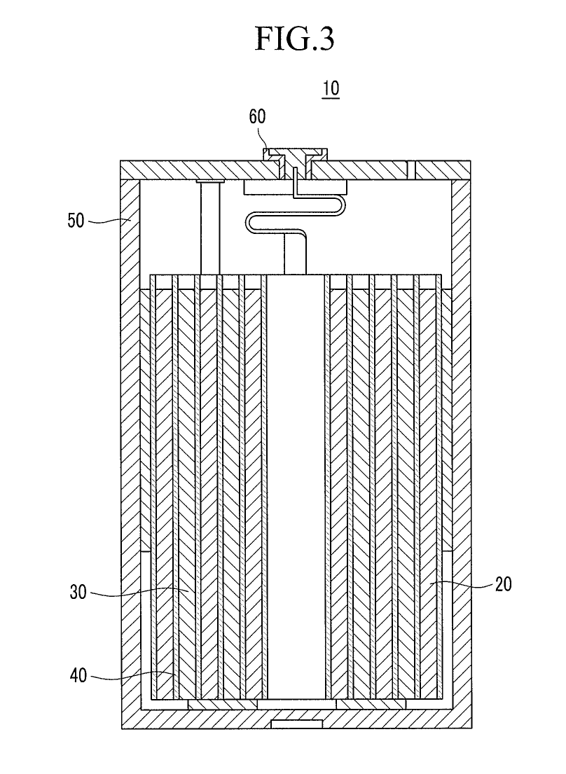

FIG. 3 is a cross-sectional view of a rechargeable lithium battery 10, according to an exemplary embodiment of the present teachings. The rechargeable lithium battery 10 includes a positive electrode 20, a negative electrode 30, a separator 40 interposed between the positive electrode 20 and negative electrode 30, an electrolyte impregnating the separator 40, a battery case 50, and a sealing member 60 to seal the battery case 50.

The negative electrode 30 is similar to the negative electrode 1. The positive electrode 20 includes a current collector and a positive active material layer disposed on the current collector. The positive active material layer includes a positive active material capable of performing electrochemical redox reaction.

The positive active material includes lithiated compounds that reversibly intercalate and deintercalate lithium ions. The positive active material may include a composite oxide including lithium and at least one selected from the group consisting of cobalt, manganese, and nickel. In particular, the following lithium compounds may be used.

LiₐA_{i-b}X_{b}D₂ (wherein, 0.95≦a≦1.1 and 0≦0.5); LiₐA_{1-b}X_{b}O_{2-c}D_{c} (wherein, 0.95≦a≦1.1, 0≦≦b≦0.5 and 0≦c≦0.05); LiₐE_{1-b}X_{b}O_{2-c}D_{c} (wherein, 0.95≦a≦1.1, 0≦b≦0.5, 0≦c≦0.05); LiₐE_{2-b}X_{b}O_{4-c}D_{c} (wherein, 0≦b≦0.5, 0≦c≦0.05); LiₐNi_{1-b-c}Co_{b}X_{c}D_{α} (wherein, 0.95≦a≦1.1, 0≦b≦0.5, 0≦c≦0.05, 0<α≦2); LiₐNi_{1-b-c}Co_{b}X_{c}O_{2-α}T_{α} (wherein, 0.95≦a≦1.1, 0≦b≦0.5, 0≦c≦0.05, 0<α<2); LiₐNi_{1-b-c}Co_{b}X_{c}O_{2-α}T_{α} (wherein, 0.95≦a≦1.1, 0≦b≦0.5, 0≦c≦0.05, 0<α<2); LiₐNi_{1-b-c}Mn_{b}X_{c}D_{α} (wherein, 0.95≦a≦1.1, 0≦b≦0.5, 0≦c≦0.05, 0<α2); LiₐNi_{1-b-c}Mn_{b}X_{c}O_{2-α}T_{α} (wherein, 0.95≦a≦1.1, 0≦b≦0.5, 0≦c≦0.05, 0<α<2); LiₐNi_{1-b-c}Mn_{b}X_{c}O_{2-α}T₂ (wherein, 0.95≦a≦1.1, 0b≦0.5, 0c<0.05, 0<α<2); LiₐNi_{b}E_{c}G_{d}O₂ (wherein, 0.90≦a≦1.1, 0≦b≦0.9, 0≦c≦0.9, 0.001≦d≦0.2); LiₐNi_{b}Co_{c}Mn_{d}GₑO₂ (wherein, 0.90≦a≦1.1, 0≦b≦0.9, 0 c≦0.5, 0≦d≦0.5, 0.001≦e≦0.2); LiₐNiG_{b}O₂ (wherein, 0.90≦a≦1.1, 0.001≦b≦0.1); LiₐCoG_{b}O₂ (wherein, 0.90≦a≦1.1, 0.001≦b≦0.1); LiₐMnG_{b}O₂ (wherein, 0.90≦a≦1.1, 0.001≦b≦0.1); LiₐMn₂G_{b}O₄ (wherein, 0.90≦a≦1.1, 0.001b≦0.2); QO₂; QS₂; LiQS₂; V₂O₅; LiV₂O₅; LiZO₂; LiNiVO₄; Li_{(3-f)}J₂(PO₄)₃ (0≦f≦3); Li_{(3-f)}Fe₂(PO₄)₃ (0≦f≦2); and LiFePO₄

In the above Chemical Formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Cu, Ag, Au, Zn, Cd, B, Al, Ga, In, TI, Si, Ge, Sn, P, As, Sb, Bi, S, Se, Te, Po, Fe, Sr, and a combination thereof; Q is selected from Ti, Mo, Mn, and a combination thereof; Z is selected from Cr, V, Fe, Sc, Y, Ti, and a combination thereof; and J is selected from V, Cr, Mn, Co, Ni, Cu, and a combination thereof.

The lithium compound may be coated with a coating layer, or the lithium compound may be mixed with another compound having a coating layer thereon. The coating layer may include at least one compound selected from the group consisting of an oxide and a hydroxide of a coating element. The compound that forms the coating layer may be amorphous or crystalline. The coating layer may include at least one element selected from Mg, Al, Co, K, Na, Ca, Si, Ti, V, Sn, Ge, Ga, B, As, Zr, or a mixture thereof. The element may be in the form of an oxide, a hydride, an oxyhydroxide, an oxycarbonate, a hydroxycarbonate, or a combination thereof. The coating layer can be formed by any suitable method, such as spray coating, impregnation, or the like.

The positive active material layer includes a binder improved adherence to the current collector, and/or a conductive material for improved electric conductivity. The binder includes one or more selected from the group consisting of polyvinylchloride, polyvinyldifluoride, an ethylene oxide-containing polymer, polyvinylalcohol, carboxylated polyvinylchloride, polyvinylidenefluoride, polyimide, polyurethane, an epoxy resin, nylon, carboxylmethylcellulose, hydroxypropylenecellulose, diacetylenecellulose, polyvinylpyrrolidone, polytetrafluoroethylene, a styrene-butadiene rubber, and an acrylated styrene-butadiene rubber.

Any suitable electrically conductive material can be used. Examples of the conductive material include natural graphite, artificial graphite, carbon black, acetylene black, ketjen black, a carbon fiber, a metal powder or a metal fiber including copper, nickel, aluminum, silver, or a polyphenylene derivative.

The positive electrode 20 may be fabricated by any suitable method, for example, by mixing the positive active material, the conductive material, and the binder, coating the resultant composition on a current collector, followed by compression. The solvent may be N-methylpyrrolidone, but it is not limited thereto.

The current collector may be one selected from the group consisting of an aluminum foil, a nickel foil, a stainless steel foil, a titanium foil, a nickel foam, a polymer substrate coated with a conductive metal, and a combination thereof. In particular, aluminum foil is appropriate in some embodiments.

The electrolyte of the rechargeable lithium battery 10 includes a lithium salt dissolved in a non-aqueous organic solvent. The lithium salts act as a lithium-ion source, facilitating basic battery operations. Examples of the lithium salt include LiSbF₆, LiAsF₆, LiClO₄, LiCF₃SO₃, LiC₄F₉SO₃, LiAlO₄, LiAlCl₄, LiₛO₃CF₃, LiCl, Lil, LiB(C₂O₄)₂, Li[N(SO₂CF₃)₂], Li[N Li[N(SO₂CF₂CF₃)₂], or a mixture thereof.

The lithium salt may be used at a 0.6 to 2.0M concentration. According to one exemplary embodiment, the lithium salt may be used at a 0.7 to 1.6 M concentration. When the lithium salt concentration is within such a range, excellent electrolyte solution performance and lithium ion mobility may be obtained, due to a desirable viscosity.

The non-aqueous organic solvent acts as a medium for transmitting ions in the electrochemical reaction of the battery 10. The non-aqueous organic solvent may include a carbonate-based, ester-based, ether-based, ketone-based, alcohol-based, protic, or aprotic solvent. Examples of the carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and so on. Examples of the ester-based solvent may include n-methyl acetate, n-ethyl acetate, n-propyl acetate, dimethylacetate, methylpropionate, ethylpropionate, γ-butyrolactone, decanolide, valerolactone, mevalonolactone, caprolactone, and so on. Examples of the ether-based solvent include dibutyl ether, tetraglyme, diglyme, dimethoxyethane, 2-methyltetrahydrofuran, tetrahydrofuran, and so on, and examples of the ketone-based solvent include cyclohexanone and so on. Examples of the alcohol-based solvent include ethanol, isopropyl alcohol, and the like, and examples of the protic solvent include diglyme (DGM), tetraglyme (TGM), and the like. Examples of the aprotic solvent include nitriles such as TCN (wherein X is a C2 to C20 linear, branched, or cyclic hydrocarbon, a double bond, an aromatic ring, or an ether bond); amides such as dimethyl formamide, dimethyl acetamide, and the like; dioxolanes, such as 1,3-dioxolane(DOX); sulfolanes; and cyclohexanes.

The non-aqueous organic solvent may be used singularly or as a mixture. When the organic solvent is used as a mixture, the mixture ratio can be controlled, in accordance with a desirable battery performance.

The carbonate-based solvent may include a mixture of a cyclic carbonate and a linear carbonate. The cyclic carbonate and the linear carbonate are mixed together at a volume ratio of about 1:1 to 1:9. When such a mixture is used as the electrolyte, electrolyte performance may be enhanced.

In addition, the non-aqueous organic solvent may include mixtures of carbonate-based solvents and aromatic hydrocarbon-based solvents. The carbonate-based solvents and the aromatic hydrocarbon-based solvents are mixed together at a volume ratio of about 1:1 to 30:1.

The aromatic hydrocarbon-based organic solvent may be represented by the following Chemical Formula 1.

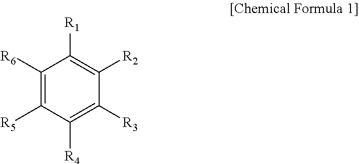

In Chemical Formula 1, R₁ to R₆ are independently selected from hydrogen, a halogen, a C1 to C10 alkyl, a haloalkyl, or combinations thereof.

The aromatic hydrocarbon-based organic solvent may include, but is not limited to, at least one selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or combinations thereof.

The electrolyte may include an additive to improve battery characteristics. For example, an ethylene carbonate-based compound represented by the following Chemical Formula 2 may be used in order to improve thermal safety.

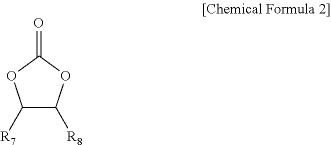

In Chemical Formula 2, R₇ and R₈ are independently hydrogen, a halogen, a cyano (CN), a nitro (NO₂), and fluorinated C1 to C5 alkyl, provided that at least one of X and Y is a halogen, a cyano (CN), a nitro (NO₂), and fluorinated C1 to C5 alkyl.

Examples of the ethylene carbonate-based compound represented Chemical Formula 2 include one selected from ethylene carbonate, fluoroethylenecarbonate, difluoroethylenecarbonate, chloroethylenecarbonate, dichloroethylenecarbonate, bromoethylenecarbonate, dibromoethylenecarbonate, nitroethylenecarbonate, cyanoethylenecarbonate, or a mixture thereof. In one exemplary embodiment, fluoroethylenecarbonate is appropriate. An amount of the ethylene carbonate-based compound is not limited, and it may be added in an amount to improve thermal safety.

The separator 40 may be one or more layers of a compound selected from polyethylene, polypropylene, and polyvinylidene fluoride, or it may be a combined multi-layer such as a polyethylene/polypropylene two-layered separator, a polyethylene/polypropylene/polyethylene three-layered separator, or a polypropylene/polyethylene/polypropylene three-layered separator.

The following examples illustrate the present teachings in more detail. These examples, however, should not in any sense be interpreted as limiting the scope of the present teachings.

### Example 1

### Fabrication of Negative Electrode

Si powder having an average particle diameter of 200 nm and Cu powder having an average particle diameter of 1 μm, were mixed at a weight ratio of 40:60, to provide a mixture. The obtained mixture was thermal-sprayed through a heating source of 15000° C., at a speed of Mach 3, toward a Cu current collector, to form an active material layer of a negative electrode for a rechargeable lithium battery. The obtained active material layer had a thickness of 20 μm.

### Example 2

### Fabrication of Negative Electrode

A negative electrode for a rechargeable lithium battery was fabricated in accordance with the same procedure as in Example 1, except that Si powder having an average particle diameter of 1 μm and Ti powder having an average particle diameter of 1 μm were mixed at a weight ratio of 50:50, to provide the mixture.

### Example 3

### Fabrication of Negative Electrode

A negative electrode for a rechargeable lithium battery was fabricated in accordance with the same procedure as in Example 1, except that Si powder having an average particle diameter of 200 nm and Cu—Al alloy powder having an average particle diameter of 1 μm were mixed at a weight ratio of 50:50, to provide the mixture.

### Example 4

### Fabrication of Negative Electrode

A negative electrode for a rechargeable lithium battery was fabricated in accordance with the same procedure as in Example 1, except that SiNi alloy powder having an average particle diameter of 200 nm and Ti alloy powder having an average particle diameter of 1 μm were mixed at a weight ratio of 50:50, to provide the mixture.

### Comparative Example 1

### Fabrication of Negative Electrode

A negative active material of Si powder having an average particle diameter of 200 nm, a binder of polyvinylidene fluoride (PVDF), and a conductive material of carbon (Super-P) were mixed at a weight ratio of 94/3/3 and dispersed in N-methyl-2-pyrrolidone, to provide a negative electrode slurry. The slurry was coated on copper foil to a thickness of 10 μm, dried, and pressed, to provide a negative electrode.

### Comparative Example 2

### Fabrication of Negative Electrode

1400° C. completely melted solution of 90% of silicon and 10% of nickel was poured into in a copper mold and quenched, to provide an ingot of silicon nickel alloy. The ingot was pulverized to obtain silicon nickel alloy particles having an average particle diameter of 0.1-10 μm. The silicon nickel alloy particles were mixed with nickel particles having an average particle diameter of 30 μm, at a weight ratio of 80:20, and pulverized using an attritor, to provide a uniform particle mixture.

The particle mixture, a conductive material of acetylene black (average particle diameter: 0.1 μm), and a binder of polyvinylidene fluoride were mixed at a weight ratio of 80/10/10 and dispersed in N-methyl-2-pyrrolidone, to provide a negative electrode slurry.

The obtained slurry was coated on a copper foil to a thickness of 35 μm and dried, to provide an active material layer having a thickness of 60 μm. The dried active material layer was then pre-pressed.

The resultant was dipped in a plating bath (nickel: 50 g/l, sulfuric acid: 60 g/l, temperature: 40° C.) to electroplate the active material layer. The resultant was roll-pressed to provide a negative electrode.

### Fabrication of Test Cell for Testing Charge and Discharge

Each negative electrode obtained from Examples 1-4 and Comparative Examples 1-2, a counter electrode of metal lithium foil, and a porous polypropylene film separator were used to form coin-type half-cells. The half-cells included an electrolyte solution, in which LiPF₆ was dissolved in a mixed solvent (PC:DEC:EC=1:1:1) of propylene carbonate (PC), diethyl carbonate (DEC), and ethylene carbonate, to provide a concentration of 1.3 mol/L.

### Expansion Rate of Negative Electrode

The obtained half-cells were charged once at 0.2 C, and the thickness of each negative electrode was measured. The thickness of negative electrode after the charge was indicated as a ratio the thickness of negative electrode before the charging and after discharging, in the following Table 1.

### Initial Charge and Discharge Capacity

The obtained coin-type half-cells were charged and discharged once at 0.2 C, at a 0.005V cut-off charge and a 1.0V cut-off discharge. The charge and discharge capacities were measured. The results are shown in the following Table 1.

### Cycle-life

The obtained coin-type half-cells were charged and discharged at 0.2 C, for 50 cycles, and the capacity after the charge and discharge was measured and compared to the initial capacity to indicate Cycle-life %, as shown in Table 1.

TABLE 1

| | Negative | | | | |
|---|---|---|---|---|---|
| | electrode | Initial | Initial | | |
| | expansion | charge | discharge | Initial | Cycle- |
| | ratio | capacity | capacity | efficiency | life |
| | (%) | [mAh/g] | [mAh/g] | [%] | [%] |
| Example 1 | 30 | 1600 | 1360 | 85 | 92 |
| Example 2 | 42 | 1200 | 996 | 83 | 93 |
| Example 3 | 25 | 1800 | 1656 | 92 | 96 |
| Example 4 | 15 | 1600 | 1296 | 81 | 89 |
| Comparative | 180 | 2020 | 1656 | 82 | 25 |
| Example 1 | | | | | |
| Comparative | 156 | 1420 | 1065 | 75 | 10 |
| Example 2 | | | | | |

As shown in Table 1, it is understood that the cycle-life characteristics significantly depended on the porosity and density in the active material layer. That is, it is confirmed that the cells including porous electrodes (Examples 1 to 4) had remarkably improved the cycle-life characteristics, as compared to the non-porous Comparative Example 1.

In addition, in Comparative Example 2, although the peeling resistance was good, the expansion of the active material during charging and discharging was excessively large, so the capacity and the cycle-life characteristic were less than those of Example 1 to 4.

Although a few exemplary embodiments of the present teachings have been shown and described, it would be appreciated by those skilled in the art that changes may be made in these exemplary embodiments, without departing from the principles and spirit of the present teachings, the scope of which is defined in the claims and their equivalents.

What is claimed is:

1. A negative electrode for a rechargeable lithium battery comprising:
a current collector; and
an active material layer disposed on the current collector, comprising:
an active material that is capable of forming a lithium-included compound; and
a solid solution of a metallic component selected from the group consisting of Cu, Ti, a Cu—X alloy, a Ti—X alloy, and a combination thereof, wherein X is selected from the group consisting of an alkaline metal, an alkaline-earth metal, a Group 13 element excluding Ti, a Group 14 element, a transition element excluding Cu, a rare earth element, and a combination thereof.

2. The negative electrode of claim 1, wherein the active material layer has a porosity ranging from about 10 volume % to about 70 volume %.

3. The negative electrode of claim 1, wherein X is selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Ru, Os, Hs, Rh, Ir, Pd, Pt, Ag, Au, Zn, Cd, B, Al, Ga, In, Si, Ge, Sn, P, As, Sb, Bi, S, Se, Te, Po, and a combination thereof.

4. The negative electrode of claim 1, wherein the active material is selected from the group consisting of Si, Sn, an Si-Q1 alloy, an Sn-Q2 alloy, and a combination thereof, wherein Q1 and Q2 are independently selected from the group consisting of an alkaline metal, an alkaline-earth metal, a Group 13 element, a Group 14 element excluding Si and Sn, a transition element, a rare earth element, and a combination thereof.

5. The negative electrode of claim 1, wherein the active material is Si or Sn.

6. The negative electrode of claim 1, wherein the active material layer comprises at least 50 wt % of the active material, based on the total weight of active material layer.

7. The negative electrode of claim 1, wherein the active material layer comprises from about 60 wt % to about 70% wt % of the active material, based on the total weight of active material layer.

8. A method of manufacturing a negative electrode for a rechargeable lithium battery comprising:
mixing an active material that is capable of forming a lithium-included compound and a metallic component selected from the group consisting of Cu, Ti, a Cu—X alloy, a Ti—X alloy, and a combination thereof, to prepare a mixture,
wherein X is selected from the group consisting of an alkaline metal, an alkaline-earth metal, a Group 13 element excluding Ti, a Group 14 element, a transition element excluding Cu, a rare earth element, and a combination thereof; and
thermal-spraying the mixture into a current collector, to produce an active material layer.

9. The method of claim 8, wherein the active material is selected from the group consisting of Si, Sn, an Si-Q1 alloy, an Sn-Q2 alloy, and a combination thereof,
wherein Q1 and Q2 are independently selected from the group consisting of an alkaline metal, an alkaline-earth metal, a Group 13 element, a Group 14 element excluding Si and Sn, a transition element, a rare earth element, and a combination thereof.

10. The method of claim 8, wherein the active material has an average particle size ranging from about 100 nm to about 1 μm.

11. The method of claim 8, wherein the metallic component has an average particle size of from about 100 nm to about 1 μm.

12. The method of claim 8, wherein the active material and the metallic component are mixed at a weight ratio of from about 30:70 to about 70:30.

13. The method of claim 8, wherein the thermal-spraying process is selected from the group consisting of plasma spraying, arc spraying, high velocity oxygen fuel spraying, gas spraying, and a combination thereof.

14. The method of claim 8, wherein the thermal-spraying is performed at a temperature ranging from about 10000° C. to about 18000° C.

15. The method of claim 8, wherein the thermal-spraying is performed at about 100 m/sec to about 400 m/sec.

16. The method of claim 8, wherein the active material and the metallic component are mixed in powder form.

17. The method of claim 8, wherein the thermal-spraying forms a solid solution of the metallic component and the active material.

18. The negative electrode of claim 1, wherein the active material layer comprises a solid solution of the metallic component and the active material.

19. The negative electrode of claim 1, wherein the metallic component is fused to particles of the active material.

20. A rechargeable lithium battery comprising:
the negative electrode of claim 1;
a positive electrode; and
an electrolyte.
